(19) United States
(12) Patent Application Publication
(10) Pub. No.: US 2005/0145646 A1
(43) Pub. Date: Jul. 7, 2005

(54) Heating device and method for heating a substance in a container

(76) Inventor: Werner Lautenschlaeger, Leutkirch (DE)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/012,751

(22) Filed: Dec. 15, 2004

(30) Foreign Application Priority Data
Dec. 17, 2003 (EP) 03 029 067.0

(51) Int. Cl. G01F 11/00

(52) U.S. Cl. 222/1; 222/146.5

(57) ABSTRACT

The disclosure relates to a method for operating a heating device, with which at least one substance in at least one container is heated in a heating chamber by radiation. In order to simplify the procedure for the mixing and/or maintaining of the mixing of the substance, the container carries out a periodic main movement Ah in the heating chamber and at least from time to time carries out a shaking movement As overlaid on the main movement Ah, whereby the amplitude Asa, Asb of the shaking movement As is smaller than the amplitude r of the main movement Ah.

### BACKGROUND

1. Field of the Disclosure

The disclosure relates to a method and device for operating a heating device for heating a substance disposed in a container.

2. Related Technology

The principle is known, for heating by means of microwave radiation at least one substance located in a container, for the container (with a container holder) to be moved in circular fashion in a heating chamber in order to obtain uniform warming or heating of the substance. As a carrier, use may be made, for example, of a turntable, on which are located standing places for the containers distributed around the circumference for simultaneous movement of several containers. The retention of the at least one container can, however, also be effected by other means, such as by suspension.

In order to guarantee, in addition, substantially uniform temperature and mixing states in the substance during the heating process, a magnetic stirrer may be inserted into the container, which is set in rotation in order to mix the substance by stirring and/or retaining the mixture.

To achieve this, an individual stirrer must be inserted into each container and then driven (see, for example, DE 197 00 499 A1). A further disadvantage of these known stirrers is that they can only be inserted into narrow containers (reagent beakers, etc.) with difficulty, and are then inclined to turn upright rather than to retain the horizontal position required for proper stirring. Finally, with regard to the automation of laboratory processes, it is almost impossible to arrange for such stirrers to be inserted by a robot and then removed. There is essentially always the risk that metal ions may pass from the magnetic core of the stirrer through the plastic sheath to the outside, and so represent a source of contamination. If sediment forms in the container, there is also the risk that the stirrer will no longer be able to dissolve the sediment and, rather, will only scratch the sediment surface.

### DESCRIPTION

The disclosure provides a method and device which will allow for a simplified mixing of substances.

With the method in accordance with a first aspect of the disclosure, a container is moved in a heating chamber with a periodic main movement and, in addition, at least from time to time with a periodic shaking movement overlaid on the main movement, whereby the amplitude of the shaking movement is smaller than that of the main movement, while the frequency of the shaking movement is greater than that of the main movement.

With the disclosed method, the substance is therefore shaken at least from time to time during its main movement. The shaking movement incurs a movement of the material in the substance, which is similar to a stirring process, and which prevents or at least reduces the segregation of different substances and/or different temperatures. With this method, no special stirring elements are required in the container, because the substance is induced by the shaking movement of the container into movements which lead to the described advantages.

It is advantageous for a shaking movement to be produced with movement components aligned transversely to the main movement. In this situation, the shaking movement engenders movements in the substance which are directed transversely to the mass forces of the substance generated by its movement in the main direction of movement. As a result of this, the mixing movement in the substance engendered by the shaking movement is particularly intensive.

The main movement is a periodic movement, which reverts in a regular or irregular fashion to a starting point. In this situation, a circulating movement is particularly advantageous, because it has a long travel length, which in turn contributes to the uniformity of the heating of the substance in the event of heating by microwaves.

A particular advantage of the disclosed method also lies in the fact that, if the shaking movement also consists of to-and-fro movement components, then to-and-fro movement components are likewise also produced in the substance. In this situation, the substance is not stirred, and the to-and-fro movements exert an effective mixing function on the substance without centrifugal forces. With the known method, by contrast, the substance is stirred exclusively, as a result of which centrifugal forces pertain in the substance, which lead to the segregation of substance constituents of different weights. The disclosed method accordingly also leads to an improvement of the mixing effect which can be exerted on the substance.

If the shaking movement is created by a movement on an orbital, preferably circular, path, not only will to-and-fro movements be exerted on the substance, but also rotational movement components directed simultaneously in the circumferential direction, whereby, in addition to the to-and-fro components taking effect in the substance, rotational components are generated, and therefore a superimposed stirring movement. As a result, the mixing function is further intensified, whereby, because of the simultaneously effective to-and-fro components, damaging centrifugal forces are avoided.

If the shaking movement has components which are directed transversely in relation to a circulating (e.g., circular) main movement, it is advantageous for the at least one carrier to be moved by a magnetic drive taking effect from outside the heating chamber. With such a drive, the carrier can simultaneously carry out the shaking movement components which are directed transversely, since the magnetic drive allows for such transverse movements.

With the disclosed heating device, a movement drive for the carrier of the container is problematic, because the parts of a movement drive arranged in the heating chamber are likewise heated by the radiation if they are formed of material which absorbs the radiation. Manufacturing these parts of materials which do not absorb radiation, however, is not generally practical, or even possible. The solution has therefore been adopted of arranging the movement drive for the main movement beneath the housing, and to engage through the base wall of the housing with drive elements, such as a shaft, in a passage aperture, and connecting it to the carrier by way of providing the drive. This leads to an elaborate design arrangement, which is then made difficult or impossible if only a restricted space is available for this movement engagement through the base wall.

The disclosure provides a device having a movement drive in a more spatially advantageous and/or more flexible manner.

With a configuration in accordance with the disclosure, the carrier can be moved by means of a magnetic engagement which has at least one drive magnet arranged outside the device housing and mounted so as to be movable on a movement path which substantially corresponds to the movement path of the carrier. With this configuration, no rigid connection with the carrier is required, and therefore no mechanical engagement through the base wall of the housing is required. A further advantage of this configuration results in that the magnetic drive allows for deviations (slippage) between the movement paths of the carrier and the drive magnet. As a result of this, the design of the device can be rendered easier, and no forced actions are incurred with the movement sequence, as would be the case with a mechanical drive. In addition to this, the magnetic drive allows in a simple manner for a shaking movement which deviates from the main direction of movement, and is therefore particularly well-suited for such a drive with superimposed shaking movement.

The disclosed configuration also makes it possible for a drive, e.g. an electric drive, to be arranged in a simple manner outside the housing and to be connected, in terms of the drive, to the drive magnet in order to move it.

In order to provide a drive force which does not take effect on one side of the bearings, it is advantageous for at least two or more magnets to be arranged on the movement path opposite one another in the plane of the movement path in each case at the magnet holder and at the carrier, in particular in each case in a pitch circle with a rotary drive. If this pair of magnets are arranged in each case with different polarity, a position coding is derived which is favorable for automation.

The disclosure encompases further refinements which allow for a small structural design which is economical to manufacture and also reliable in function. Other refinements relate to heat protection for additional drive elements which engage from below through the base wall of the housing, in particular an eccentric shaft for a shaking movement.

### BRIEF DESCRIPTION OF THE DRAWINGS

The disclosed method and device are explained in greater detail with reference to advantageous features of at least one embodiment and on the basis of drawings. These show:

FIG. 1—A heating device for heating a substance located in at least one container, in vertical section;

FIG. 2—A portion of the device in horizontal section according to the line II-II in FIG. 1.

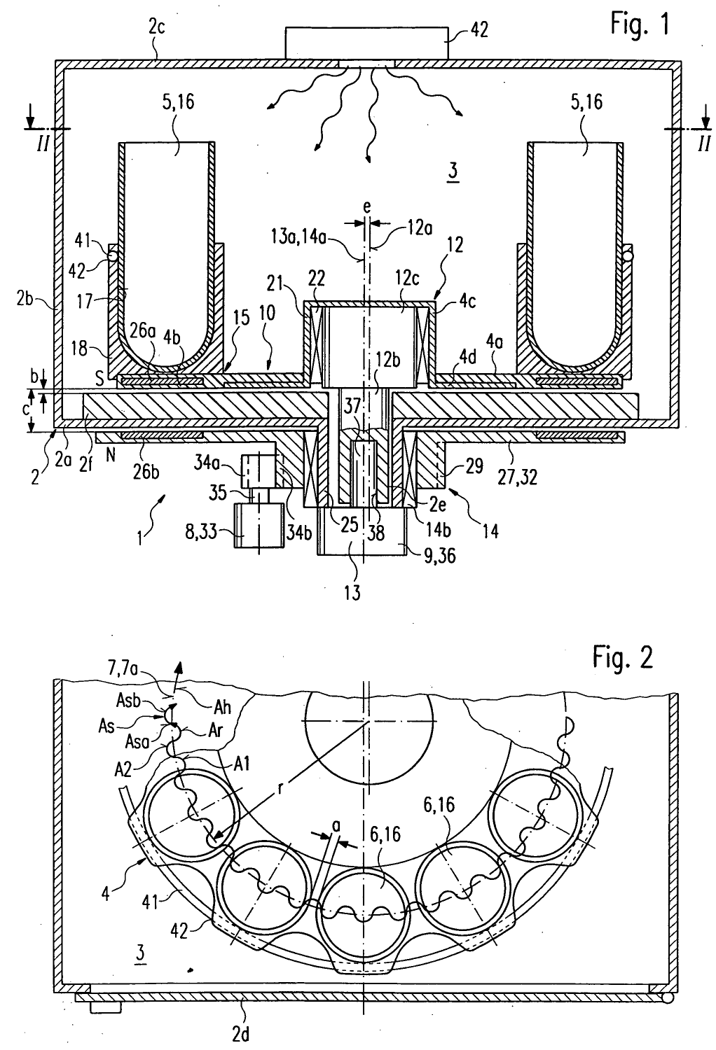

### DETAILED DESCRIPTION

The main parts of an exemplary heating device, generally designated 1, are a housing 2 with a substantially horizontal and flat base wall 2a, a circumferential wall 2b, and a substantially horizontal and, for example, flat cover wall 2c, which together surround a closed heating chamber 3, which is accessible from the outside through a door 2d which is optionally to be closed and opened. Mounted on bearings so as to be movable in the floor area of the heating chamber 3 is at least one carrier 4 for one or more containers 5 for a substance 6 which is to be treated with heat.

The carrier 4, and therefore the container 5 secured to it so as to move with it, can carry out a movement in the heating chamber 3 which is composed of a main movement Ah and a shaking movement As superimposed on the main movement Ah. The main movement Ah is periodic and includes at least two identical or different movement sections, in which the carrier 4 reverts to a starting point in a regular or irregular manner. The main movement direction is designated 7. In the embodiment, the main movement Ah is a circulating movement, preferably a circulating movement running around on a circular line, and can therefore be attained by means of rotation about a substantially vertical axis of rotation or to-and-fro movement of the carrier 4. As an alternative, the main movement can, for example, be a translatory to-and-fro movement. The movement device which creates the resultant movement Ar is generally designated 10.

In the event of heating by microwaves, the main movement is selected in such a way that each container runs through such areas of differing radiation intensity throughout the duration of the treatment. The shaking movement As in the embodiment is a periodic zig-zag or snaking movement, of which, at least in sections, transverse components Asa, Asb, running transversely to the main direction of movement 7, have the amplitudes A1, A2, and cross an abscissa, in this case the circle line 7a. The amplitudes At of the shaking movement As are smaller than the amplitude of the main movement Ah, which in the case of a circular movement corresponds to the radius r.

The frequency of the shaking movement is greater than that of the main movement.

It is the purpose of the shaking movement As to keep in motion the material 6, in particular fluid or capable of flowing, in the container 5 during the function operation of the device 1, in order, for example, to avoid a sedimentation and to guarantee the mixing of the substance 6.

It is of advantage, in order to increase the performance efficiency of the device 1, for several carriers 4 to be provided for, which are distributed on the main movement path. In the embodiment, several carriers 4 are arranged distributed on the circle line 7a, whereby the carrier 4 can be formed by a disk 4a or a ring.

A circular main movement Ah can, as indicated above, be achieved in a simple and space-saving manner by the carrier 4 being mounted in a rotatable manner in a first rotary bearing 12 so as to rotate about an axis of rotation 12a which preferably is substantially vertical. A drive pertaining to this, and is described below, is designated.

The shaking movement As can be obtained in a simple manner in that the at least one carrier 4 is moved to-and-fro transversely to the main movement. The frequency of this shaking movement As is a multiple of the revolution speed of the carrier 4 about the axis of rotation 12a. The frequency can be, for example ten times the revolution speed or more.

In the embodiment, the shaking movement As is produced by the carrier 4 being moved on a planetary path which is preferably circular, in particular by the carrier 4, with its axis of rotation 12a, being moved on a planetary path, preferably circular, during its main movement Ah, simultaneously about an axis of rotation 13a of a second rotary bearing 13, eccentric to the axis of rotation 12a. This is achieved in an advantageous manner by the bearing axis of the first rotary bearing 12 being a shaft, which is mounted so as to be capable of rotating about the eccentric axis of rotation 13a. The eccentric mass in this case represents the amplitude of the shaking movement.

A spatially advantageous bearing position for the second rotary bearing 13 is beneath the housing 2. The shaft 12b can in this situation access in a simple manner to the base wall 2a downwards in a hole 2e and can be in connection with the shaking movement drive 9. The second rotary bearing 13 can therefore be integrated into this second drive 9.

The frequency of the shaking movement As is so great that a shaking movement is exerted on the substance 6 located in the container 5, as a result of which the substance 6 is displaced in a to-and-fro manner in the container 5, and therefore undergoes thorough mixing. If the second movement 7b is a circular movement, then, in addition, a stirring movement of the substance 6 is produced.

It is also advantageous for the carrier 4 to be driven by means of magnetic engagement 8 through the heating chamber wall in order to carry out its main movement Ah. On the one hand, this makes it possible for a drive motor pertaining to this, as well as a drive magnet, to be disposed outside the housing 2, whereby the electromagnetic drive forces are effective through the wall of the housing 2. As a result of this, it is possible for the majority of the parts forming the drive to be disposed outside the housing 2, where they are largely withdrawn from the heat of the heating chamber 3, and a larger structural space is therefore provided.

A further advantage of a magnetic drive lies in the fact that, because of the absence of a rigid connection, it allows for slippage between the drive 8 and the carrier 4, and in particular the transverse movements and shaking movement As respectively running transversely to the main direction of movement 7.

With the illustrated embodiment, the carrier 4 is rotatably mounted in the first rotary bearing 12 about the axis of rotation 12a, and has several placement positions 15, for containers 5 which are preferably of the same design as one another, distributed on both sides of the axis of rotation 12a and on its circumference. Provision can be made, on a pitch circle, for containers 5 arranged at a slight distance a from one another, e.g. up to some 14 containers.

The container 5 can be formed by a vessel 16, preferably round in shape and open to the top, which stands with a foot on the placement position 15 pertaining to it. The container 5 can, however, also be located in an accommodation hole 17, with a slight degree of movement play, this hole being arranged in a carrier base part 18 which forms the carrier 4, which can, for example, be an upright tube of the carrier 4 or an upright ring wall extending continuously in the circumferential direction. The base part 18 is, for example, connected in spoke fashion or by means of a disk 4a to a hub 21, in which the first rotary bearing 12 is formed. This can be a slide bearing or roller bearing 22, which is arranged between the hub 21 and an axle or shaft 12b, which extends from the rotary bearing 12 downwards with movement play through the hole 2e in the base wall 2a and a bearing bush or sleeve 25 for a third rotary bearing 13 for the magnetic drive 8. In the embodiment the third rotary bearing 13 is disposed beneath the base wall 2a, whereby the bearing bush 25 is secured to the base wall 2a and projects downwardly therefrom. The base part 18 or disk 4a respectively have a vertical distance b from the base wall 2a or a plate 2f lying on it.

In the illustrated embodiment, the main movement drive 8 for the carrier 4 is a magnetic movement drive with at least two magnets 26a, 26b, of which the first magnet 26a is arranged at the carrier 4 and the second magnet 26b, as the drive magnet, is disposed opposite the circulating path, preferably circular, of the first magnet 26a, at a drive rotary part 27 disposed outside the housing 2, and which is capable of rotation in a third rotary bearing 14 about an axis of rotation 14a, which runs approximately vertical in the area of the axes of rotation 12a and 13a, e.g. co-axially with the axis of rotation 13a of the second rotary bearing 13. The drive rotary part 27 has a hub 29, which preferably projects downwardly and is rotatably mounted by means of a slide bearing or roller bearing 14b on the bearing bush or sleeve 25. The drive rotary part 27 is also formed in disk shape, e.g. with an approximately horizontal disk 32, which is connected to the upper edge of the hub 29 and which projects radially from this in the form of a flange.

The magnets 26a, 26b are preferably flat magnets, whereby at least the one magnet 26a is arranged on the under side of the carrier 4 or carrier base part 18 or of the disk 4a, preferably being embedded in this, and which can be covered by a material layer 4b on the under side. The second magnet 26b or drive magnet respectively is arranged at the upper side of the drive rotary part 27 and preferably sunk into it, whereby its upper sides can close with one another. The distance c, preferably vertical, between the magnets 26a, 26b amounts in particular to less than about 15 mm, e.g. about 5 mm.

The drive rotary part 27 can be driven by an electric motor 33, which in terms of the drive is connected to the drive rotary part 27, e.g. by means of intermeshing gearwheels 34a, 34b, of which one is located on a drive shaft 35 of the motor 33 and can be a pinion, which can mesh with a ring gear or toothed rim forming the gear wheel 34b, which on the under side is connected to the drive rotary part 27 and/or with the bearing bush or sleeve 29.

The second movement drive 9 has an electric motor 36, which drives the shaft 12b, for example by being connected to the drive shaft 37 of the motor 36. For this purpose, the shaft 12b can have an accommodation hole 38, co-axial in relation to the second axis of rotation 13a, with which it is located on the drive shaft 37 and is connected to this in a torsionally-resistant manner, e.g. by means of a wedge connection. The bearing head 12c forming the first rotary bearing 12 is arranged eccentrically in relation to the shaft 12b, by the eccentricity e of the axes of rotation 12a, 13a. The electric motor 36 can, for example, be secured to the bearing bush or sleeve 25.

Within the framework of the disclosure, two magnets 26a, 26b can be sufficient to create a magnetic sympathetic carrying force, which is sufficiently great that, at a rotation of the drive rotary part 27, the carrier 4 is carried in sympathy in the main direction of movement 7. In order to increase the sympathetic carrying force, it is advantageous for several magnets 26a, 26b, e.g. at least two, to be arranged distributed on the circumference, as a result of which several contact points for the sympathetic carrying force are created, arranged distributed on the circumference. The magnets 26a, 26b, e.g. permanent magnets such as neodyme magnets, in each case have a reversed polarity. Accordingly, if the driving drive part 27 is rotated, they draw the carrier 4, with the container(s) 5, with them by means of the magnetic sympathetic force.

In the embodiment with several (e.g., two) segment-shaped magnets 26a, 26b, position encoding is effected by means of the polarity of the magnets. Inasmuch as in each case the one magnet 26a has a south polarity and the other magnet 26b has a north polarity S, N, and the same also applies to the at least two magnets 26a of the carrier 4, the drive rotary part 27 will rotate at the start of the rotation process until the north magnet of the carrier 4 is located substantially beneath the south magnet of the drive rotary part 27, and therefore, at the same time, the south magnet of the drive rotary part 27 is located substantially beneath the north magnet of the carrier 4. The provision in each case of two magnets 26a, 26b, accordingly has the advantage that the axial forces are compensated for, and the third roller bearing 14 is therefore subjected to less load.

The heating device 1 is preferably a microwave device, with which, in order to generate the heat desired in the heating chamber 3, microwaves produced by a generator 42 are coupled into the heating chamber 3.

For a function operation, at least the first movement drive 8 is switched on, which moves the carrier 4 and the container(s) 5 which it carries are moved on the movement path in the main direction of movement 7, which is preferably circular, and moves the at least one container 5 in a circulatory manner through the heating chamber 3. As a result of this, microwaves are uniformly imposed on the substance 6, and therefore uniform heating of the substance 6 is achieved. The heating device 1 is therefore functionally capable of actuating and/or promoting mixtures or physical processes in the material 6, e.g. specimen material.

At the same time, the carrier 4, with its axis of rotation 12a, moves by means of the second movement drive 9 on a planetary path, preferably circular, about the axis of rotation 13a, as a result of which, because of the eccentricity e, the amplitude movements Asa, Asb are created, directed transverse to the main direction of movement 7. The frequency and revolution speed or speed of the shaking movement As are sufficiently great that, when removed and brought close again, a to-and-fro centrifugal force is exerted on the substance 6, which is so great that the substance 6 moves to-and-fro in the container 5, which contributes to the mixing of the material. The shaft 12b is driven at a correspondingly high revolution speed. In function operation, the carrier 4 is not only rotated about the first axis of rotation 12a, but this axis of rotation 12a is at the same time rotated at higher frequency or revolution speed about the second axis of rotation 13a. The carrier 4 leads in this situation to a planetary movement which is preferably circular and at the same time exerts a superimposed eccentric movement, which not only leads to the shaking movement As, but also, because of the rotation, creates a stirring movement in the substance 6, directed in the circumferential direction of the container 5.

The eccentricity e is small and typically amounts to less than about 5 mm, e.g. 1 mm to 2 mm (by comparison, the amplitude of the main movement lies in a range of at least several centimeters).

The revolution speed of the carrier 4 in relation to the axis of rotation 12a amounts, for example, to between 1 rev/min and 30 rev/min. With the eccentric extension, the revolution speed can, for example, lie between some 20 rev/min and 2000 rev/min.

The parts located in the heating chamber 3 of the device 1, which are not intended to be heated by the microwave radiation, such as, for example, the container(s) 5 and the carrier parts and drive parts, are made of material which is permeable to microwaves, plastic in particular.

In order to be able to make use of metal for the first roller bearing 12, e.g. a roller bearing, the disk 4a has in its middle section a disk part 4c made of metal, e.g. steel, on or in which the rotary bearing 12 is arranged, and to which the outer disk part is secured, and which lies, for example, on a lower flange 4d of the disk part 4c. The disk part 4c screens the rotary bearing 12 against the radiation.

To secure the containers 5, provision may be made for a strip 41 which surrounds them with a slight tensile tension, arranged, for example, in grooves 42 in the carrier base part 18, which set the wall so low that the strip 41 presses against the container 5.

1. A method for operating a heating device having a heating chamber to heat at least one container in the heating chamber, comprising
carrying out a main movement of the container in the heating chamber having an amplitude and a frequency and at least intermittently carrying out a shaking movement of the container having an amplitude and a frequency simultaneously with the main movement, wherein the amplitude of the shaking movement is smaller than the amplitude of the main movement and the frequency of the shaking movement is greater than that of the main movement.

2. The method of claim 1, wherein the shaking movement has movement components which are directed transversely to movement components of the main movement.

3. The method of claim 2, wherein the main movement and the shaking movement produce a resultant movement which runs in a zig-zag or snaking fashion in the direction of the main movement.

4. The method of claim 3, wherein the shaking-circular movement is effected by means of an eccentric drive.

5. The method of claim 1, wherein the main movement is a circulating movement.

6. The method of claim 5, wherein the main movement is a circular movement.

7. The method of claim 1, wherein the shaking movement is a circulating movement.

8. The method of claim 7, wherein the shaking movement is a circular movement.

9. The method of claim 1, wherein the main movement is effected by magnetic engagement through a wall of the heating chamber.

10. A method for operating a microwave heating device having a microwave heating chamber with which at least one container is heated in the microwave heating chamber, comprising carrying out shaking movement of the container in the heating chamber during application of microwave radiation.

11. A device for heating at least one substance in a container, comprising
a housing, which defines a heating chamber,
at least one carrier for a container for accommodating the substance, and,
a movement device for moving the carrier with a periodic main movement having am amplitude in a main movement direction in the heating chamber,
wherein the movement device is arranged to shake the carrier with a shaking movement having an amplitude superimposed on the main movement, wherein the amplitude of the shaking movement is smaller than the amplitude of the main movement.

12. The device of claim 11, wherein several carriers are distributed on the main movement path.

13. The device according to claim 12, wherein the carriers are rotatably mounted in a rotary bearing with a substantially vertical axis of rotation.

14. The device of claim 13, wherein the carrier is mounted on a planetary path capable of rotation about a second axis of rotation which is eccentric in relation to the first axis of rotation.

15. The device of claim 14, wherein the planetary path is circular.

16. The device of claim 11, wherein the movement device moves the carriers during the main movement with components of the shaking movement running transversely to the main direction.

17. The device of claim 11, wherein two drives are provided for the drive of the main movement and the shaking movement, which are arranged beneath the housing, and of which at least one drive engages with drive means through a base wall of the housing.

18. The device of claim 11, comprising a magnetic drive for moving the carrier, with a drive magnet disposed outside the housing at a magnetic holder, and movable in accordance with a movement path of the main movement.

19. The device of claim 11, wherein the main movement is a circulating movement.

20. The device of claim 19, wherein the main movement is a circular movement.

21. The device of claim 11, wherein the shaking movement has components which are aligned transversely to components of the main movement.

22. The device of claim 11, wherein the main movement and the shaking movement produce a resultant movement which runs in a zig-zag or snaking movement in the main movement direction.

23. The device of claim 11, wherein the shaking movement is a circulating movement.

24. The device of claim 23, wherein the shaking movement is a circular movement.

25. The device according to claim 24, wherein the shaking-circular movement is effected by means of an eccentric drive.

26. Device for heating at least one substance in a heating chamber by radiation, comprising
a housing, which encloses the heating chamber,
at least one carrier for at least one container for accommodating a substance, said carrier having magnetic sections,
a movement device for moving the carrier with a periodic main movement in the heating chamber, and
a magnetic drive and a drive magnet disposed outside the housing at a magnetic holder and capable of being moved in accordance with the movement path of the main movement.

27. The device according to claim 26, comprising at least one magnet disposed at the magnet holder and at the carrier, distributed opposite one another on the movement path of the main movement.

28. The device of claim 27, wherein each magnet is a flat magnet.

29. The device of claim 26, wherein at least one of the carrier and the magnet holder is mounted so as to be capable of rotation about a substantially vertical axis of rotation.

30. A device for heating at least one substance in a heating chamber by radiation,
wherein the substance is present in at
